(19) United States
(12) Patent Application Publication
(10) Pub. No.: US 2003/0120546 A1
(43) Pub. Date: Jun. 26, 2003

(54) System and method for facilitating real-time web-based point of sale (Pos) transactions and operations

(75) Inventors: Bob Cusack, Germantown, MD (US); Lee M Hindin, Potomac, MD (US); Brian Taff, Potomac, MD (US)

Correspondence Address: ERIK B CHERDAK & ASSOCIATES LLC, 11300 ROCKVILLE PIKE, SUITE 906, ROCKVILLE, MD, 20852, US

(73) Assignee: BRACEWELL & PATTERSON LLP

(21) Appl. No.: 09/519,332

(22) Filed: Mar. 7, 2000

(51) Int. Cl. G06F 17/60

(52) U.S. Cl. 705/16

(57) ABSTRACT

System and method for facilitating real-time, web based point of sale operations such as sales, reporting, etc. The system and method include and involve a central database management facility storing and managing data related to at least one user interface form operable within a browser application and to items which may be sold or otherwise processed at a point of sale. Also included and involved is a plurality of client data processing facilities which are coupled to the central database management facility via an electronic data network. Each client data processing system is located at a remote point of sale and is coupled to the central database management facility via a network connection over the electronic data network. Each client data processing facility is configured to execute the browser application, to access the central database management facility via the network connection to retrieve and process at least one user interface form within the browser application, to access the central database management facility in real time to retrieve data related to at least one of the items to facilitate a remote point of sale related operation, and to cause the central database management facility to manage the data based on the remote point of sale related operation.

### BACKGROUND OF THE INVENTION

1. Field of the Invention

The present invention relates to systems and methods used to facilitate point of sale transactions. More particularly, the present invention relates to systems and methods used to facilitate point of sale transactions and operations via a global network, such as the Internet and World Wide Web (WWW).

2. Description of the Related Art

Point of sale systems and processes such as those used in fast food, restaurant, and retail store environments are well known. For years, point of sale systems have been the focus of business practices as both providers and commercial users of point of sale systems strive for greater efficiencies that can lead to increased revenues and, ultimately, higher profits. As a result, providers have developed a wide variety of point of sale (POS) systems from simple cash registers to elaborate networked systems.

Since the advent of the cash register, for example, developers have strived to improve on the number of features such machines possess, and the ability of such machines to provide management reporting and accounting functions. Unfortunately, such machines have become all but obsolete for the modern retail business enterprise that may include remotely located POS stations and the like within geographically dispersed stores/establishments that may make up a multiple facility enterprise such as a chain of co-owned or operated restaurants, etc.

At the other end of the spectrum, currently available network based POS systems attempt to address the need for enhanced services and reporting functions. Such systems are commonplace in today's retail marketplace. Unfortunately, however, such modern systems are not without their problems. For example, even the most sophisticated systems used today in multiple facility enterprises (e.g., chain restaurants, etc.), for example, require elaborate software and hardware based local POS networks (sophisticated local area networks or LANs) at each retail store location. Typically, data is stored locally on each POS network or within each POS terminal device. A retailer that owns more than one store, or a chain of stores, in order to gather data relating to all locations, typically has to download data from each POS network on a regular, periodic basis, such as nightly. Downloads are commonly made via dedicated modem lines and may use complex, customized download programs. Unfortunately, only after periodic downloads can business personnel such as store or regional managers analyze company/enterprise wide data to derive enterprise based management reports such as sales reports, inventory reports, etc. to better run and operate their businesses.

An example of a modern POS system which may be used in a multiple facility enterprise is shown in a drawing figure which has been attached to this patent document and which has been identified as “FIG. 1A.” In particular, in FIG. 1A, an exemplary enterprise wide POS system 10 includes several stores 102, a download facility 108, a pricing system, and an enterprise system 116. Each store 102 (e.g., a restaurant, retail store, etc.) within the multiple facility enterprise within POS system 10, has a POS network containing a plurality of POS terminals 104 linked together via a LAN, such as one incorporating an Ethernet backbone. Each POS terminal contains data relating to the items (goods, services, etc.) to be sold in the store, and is configured to perform standard POS functions, such as executing purchases (cash, credit card, etc.), enabling coupon redemption, providing returns and refunds, performing credit card transactions, engaging in credit card settlement transactions, permitting cash/drawer transactions, etc. During business hours, POS terminals are the center of business transactions, storing transaction data locally as transactions (e.g., sales, returns, etc.) occur. After business hours, a store manager, for example, may place the POS systems into a reconciliation mode to reconcile the day's business across the POS network. Unfortunately, to consolidate enterprise wide data, each store 102 uploads its data periodically (e.g., nightly, etc.), or in response to a polling type operation initiated by enterprise system 116 in conjunction with an application such as one provided via application program interface “API” 112, for example.

Typically, such transmission of data is done over standard telecommunications or modem lines 106 (e.g., telephone lines which may be dedicated, leased, or plain old telephone “POTs” lines) to some sort of a download (or upload) facility 108. For some enterprises that may have tens or even hundreds of remote facilities such as remote franchises, etc. periodic downloads/uploads may be performed over dozens of modems and may take hours, or may not be possible at all. And, because of the bandwidth issues, etc. prior art systems similar or like those depicted in FIG. 1A typically cannot integrate individual retail store data with enterprise wide data until all download/upload operations are complete. And, since store-based data is transferred at the end of business period, once a week, etc., company wide retail store data cannot be integrated in real time.

In addition to being unable to efficiently and effectively gather and consolidate enterprise wide data to drive management and post-POS functions, for example, POS systems like or similar to those shown in FIG. 1A do not permit real-time changes to inventory data to bring about enterprise or store-wide changes. For example, modern POS systems do not permit item price changes in real time to affect global changes in sales prices, etc. Such adjustments must either be done locally on each POS network, within each POS terminal 104, or via some other infrastructure change. At best, an enterprise may deploy a pricing system 114 in conjunction with an appropriate application such as one provided via API 112, which functions to disseminate pricing data to at least one store 102 during scheduled synchronization operations and, certainly, not in real time.

Accordingly, POS systems similar or like those shown in FIG. 1A do not permit enterprise personnel, owners and operators, etc. to obtain data in real time to drive better and more efficient business processes. And, since modern systems do not permit item data changes to be made in real time, global changes cannot be made instantaneously to affect individual sales in real time. As such, many types of enterprise management decisions cannot be made effectively because of the lack of real time enterprise data.

Thus, there exists a need to provide new and improved POS systems and methods. Such systems and methods should provide real time enterprise wide data management. And, to be viable, such systems and methods must be implemented without causing significant burdens to network infrastructures or undue increases in infrastructure costs.

### SUMMARY OF THE INVENTION

In view of the foregoing comments regarding the related art, the principal object of the present invention is to solve the aforementioned problems. It is another object of the present invention to provide new and improved systems and methods for facilitating point of sale transactions and operations in real time and via a network connection such as via a web connection.

In achieving its objects, certain benefits of the present invention are realized which have not heretofore been possible. For example, the present invention now permits real time access to consolidated, centrally stored inventory and related data, to drive generation and storage of real-time transaction and operation data. As such, both POS operations and transactions and back end type processes can take advantage of real time data storage to facilitate small-footprint infrastructures and up-to the-minute management reporting capabilities, respectively. And, because the present invention takes advantage of modern communications infrastructures such as the Internet and World Wide Web (WWW), what used to be done with elaborate, custom built, and expensive hardware based platforms may now be enhanced and provided via easily modifiable software backbones that are more efficient and cost effective to implement.

As such, the present invention achieves the above-stated and other objects to deliver the aforementioned benefits by providing new and improved systems and methods for facilitating real-time, web based point of sale operations such as sales, reporting, etc. The system and method include and involve a central database management facility storing and managing data related to at least one user interface form operable within a browser application and items which may be sold or otherwise processed at a point of sale. Also included and involved is a plurality of client data processing facilities which are coupled to the central database management facility via an electronic data network. Each client data processing system is located at a remote point of sale and is coupled to the central database management facility via a network connection over the electronic data network. Each client data processing facility is configured to execute the browser application, to access the central database management facility via the network connection to retrieve and process at least one user interface form within the browser application, to access the central database management facility in real time to retrieve data related to at least one of the items to facilitate a remote point of sale related operation, and to cause the central database management facility to manage the data based on the remote point of sale related operation.

### BRIEF DESCRIPTION OF THE DRAWING FIGURES

The present invention is described in detail below with reference to the attached drawing figures, of which:

FIG. 1A is a block diagram of a prior art point of sale system;

FIG. 1B is a block diagram of a point of sale system according to a preferred embodiment of the present invention;

FIG. 2A is a block diagram that illustrates an automatic data processing system (ADP) which may be configured to facilitate the operations of component parts of a point of sale system provided in accordance with the present invention;

FIG. 2B is a diagram of a point of sale terminal which may be used within a point of sale system provided in accordance with a preferred embodiment of the present invention;

FIG. 3A is a screen shot of a user-interface implemented as an HTML document (web page) that includes mark-up scripts and, possibly, other scripts such as those implemented using enhanced language scripts (e.g., MICROSOFT ACTIVE-X control scripts, Javascript, etc.) and which facilitates an enterprise wide point of sale system according to a preferred embodiment of the present invention;

FIG. 3B is another screen shot of a web page used to facilitate POS operations and transactions according to a preferred embodiment of the present invention;

FIG. 3C is another screen shot of a web page used to facilitate POS operations and transactions according to a preferred embodiment of the present invention;

FIG. 3D is another screen shot of a web page used to facilitate POS operations and transactions according to a preferred embodiment of the present invention; and

FIG. 4 is a flow chart that illustrates certain steps of a method which may be used within the system shown in FIG. 1B to facilitate real time web based POS operations and transactions in accordance with a preferred embodiment of the present invention.

### DETAILED DESCRIPTION OF THE PREFERRED EMBODIMENTS

A point of sale (POS) system and, in particular, one facilitating real-time, web based point of sale (POS) transactions and operations in accordance with a preferred embodiment of the present invention is next described in detail with reference to the drawing figures that were briefly described above. Unless otherwise specified, like parts and processes are referred to with like reference numerals.

In the context of the present invention an “item” refers to any good or service about which data may be processed in relation thereto in a POS system provided by the present invention. Accordingly, an item may be purchased/sold at a point of sale, thus causing at least one corresponding database operation to occur in the context of the present invention. Moreover, queries related to items operated upon at a point of sale may be carried in the context of the present invention. Such queries may be used to derive management reports, etc. based on POS transaction data stored and managed in real time.

A “point of sale” or “POS” refers to a place or connection at which or over which an item may be purchased, sold, or otherwise operated upon. Additionally, a POS may, in accordance with the present invention, includes a data processing system that is configured to access the systems and processes provided by the present invention to engage in some type of operation related to items purchased or otherwise operated upon. So, a POS would include a personal computer at which management personnel coupled to the systems and methods provided by the present invention may engage in generation of a management report (e.g., a sales related report, an inventory update report based on real-time data, etc.) related to data stored and management in real-time. Each POS (system) provided in accordance with the present invention is capable of running an entire POS system to facilitate web based, real time POS transactions and operations.

### Structural Aspects of the Present Invention

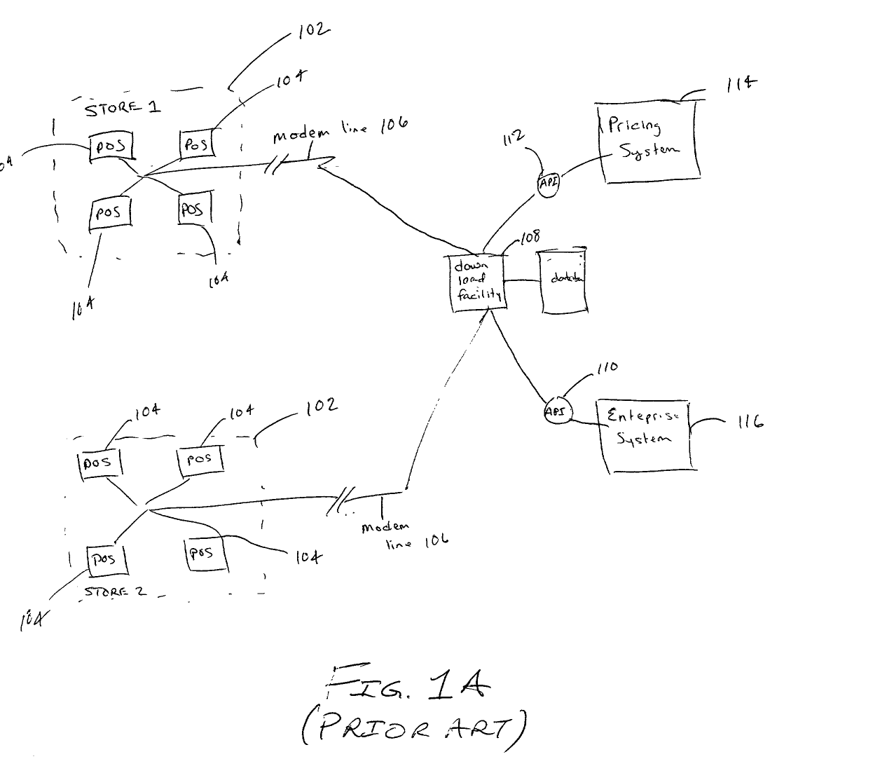

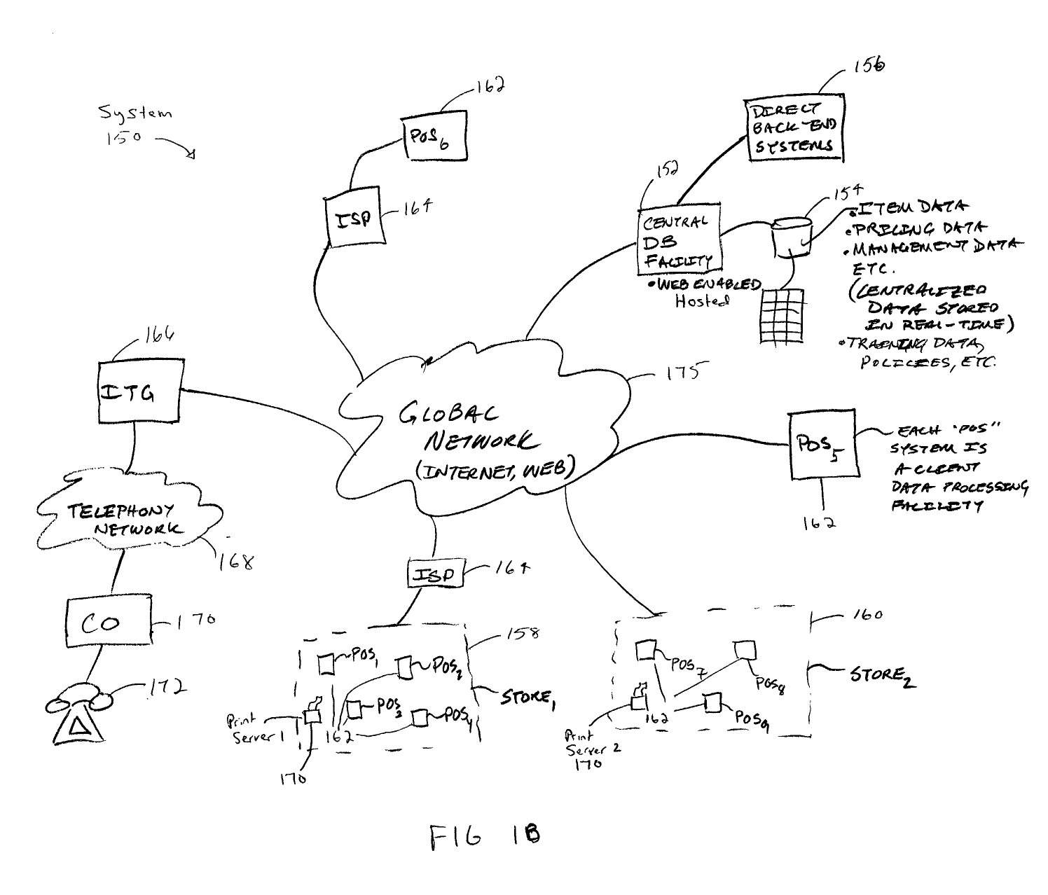

Referring now to FIG. 1B, depicted therein is a POS system which facilitates real-time, web based POS operations according to a preferred embodiment of the present invention. POS system 150 is a web based POS system that performs all the functions of a present day system with the addition of an enterprise wide solution to the aforementioned problems associated with the prior art as discussed above with reference to FIG. 1A. POS system 150 may include a plurality of remotely located retail establishments (possibly among disparate retail vendors) including multiple facility locations shown as store 1 and store 2 (phantom lines). Each remotely located retail establishment includes at least one POS terminal 162 (denoted in FIG. 1B as POSx where x is the subscript that indicates any number of POS terminals) and a print server 170. Each POS terminal is capable of running an entire POS system in accordance with the present invention.

POS system 150 further includes an application server 152 and a central database 154 which can be integrated with back office systems 156. Application server 152 can be any well know web server that is coupled to a network 175 (e.g., a globally accessible network such as the Internet and World Wide Web (WWW), a network incorporating open-standards based technologies and protocols, etc.) and is configured to serve and process content such as web pages in accordance with the present invention.

Application server 152 is coupled to central database 154 and is configured so that systems and processes running with and on application server 152 can make real-time inserts, updates, queries and deletions, and perform other database operations in relation to data stored in central database 154. For example, such real-time database operations may include real-time price changes related to particular items about which POS transactions may relate (e.g., sale transactions, etc.). In particular, the present invention and, in particular, system 150 now permits real-time changes to pricing data say for a large drink at perceived peak times during a business period to maximize revenue or sales, etc. In particular, the present invention now permits a user (e.g., a regional store manager associated with a multiple facility enterprise) to access a web connection and change pricing data, quantity and availability data, etc. to more effectively meet changing market conditions to enhance sales, increase revenues, etc. And, a price or other datum may be reduced to aid slow moving inventory based on real-time transaction data analysis. The present invention now provides real-time control over what may be a global enterprise via a common and well know user medium—the Internet and WWW.

Additionally, system 150 permits centralized storage of enterprise data including training materials and employee policies which may be used to remotely train store personnel, etc. Store employees can now log into central facilities that can house and serve multi-media presentations that train, for example, personnel on proper sales practices, etc.

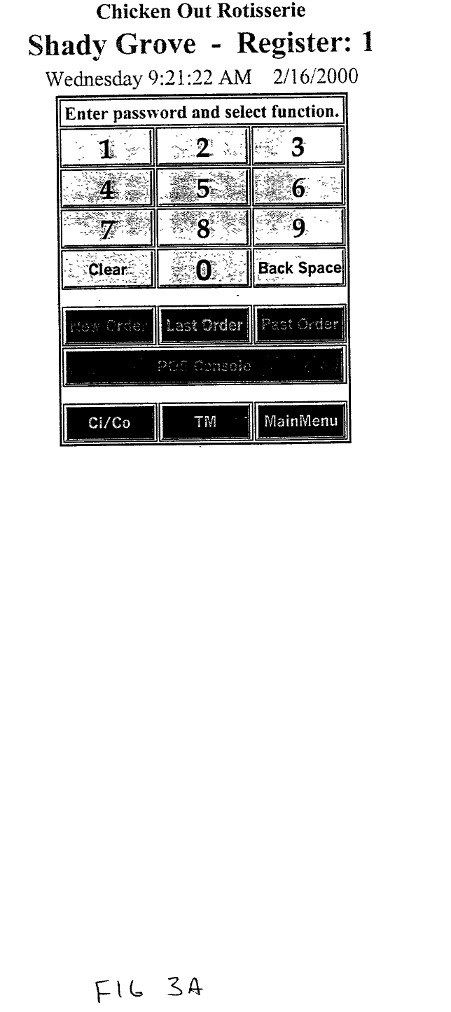

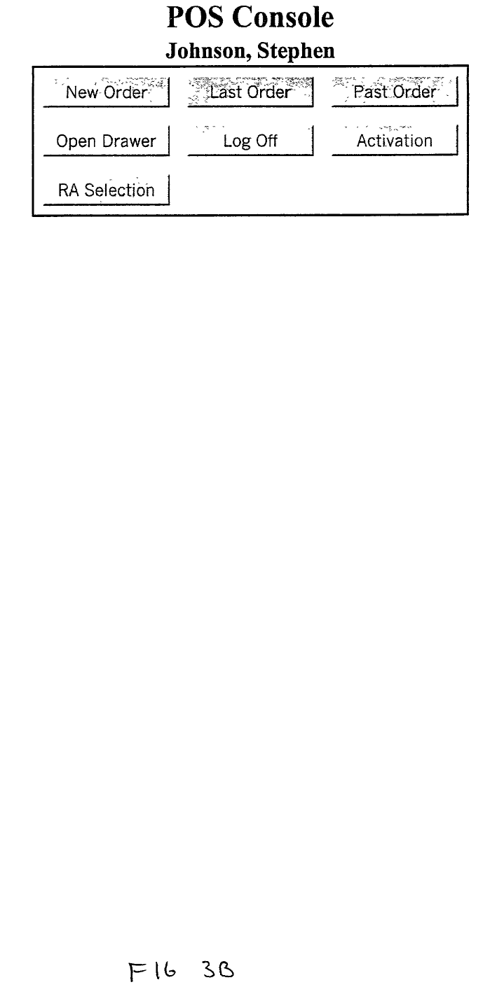

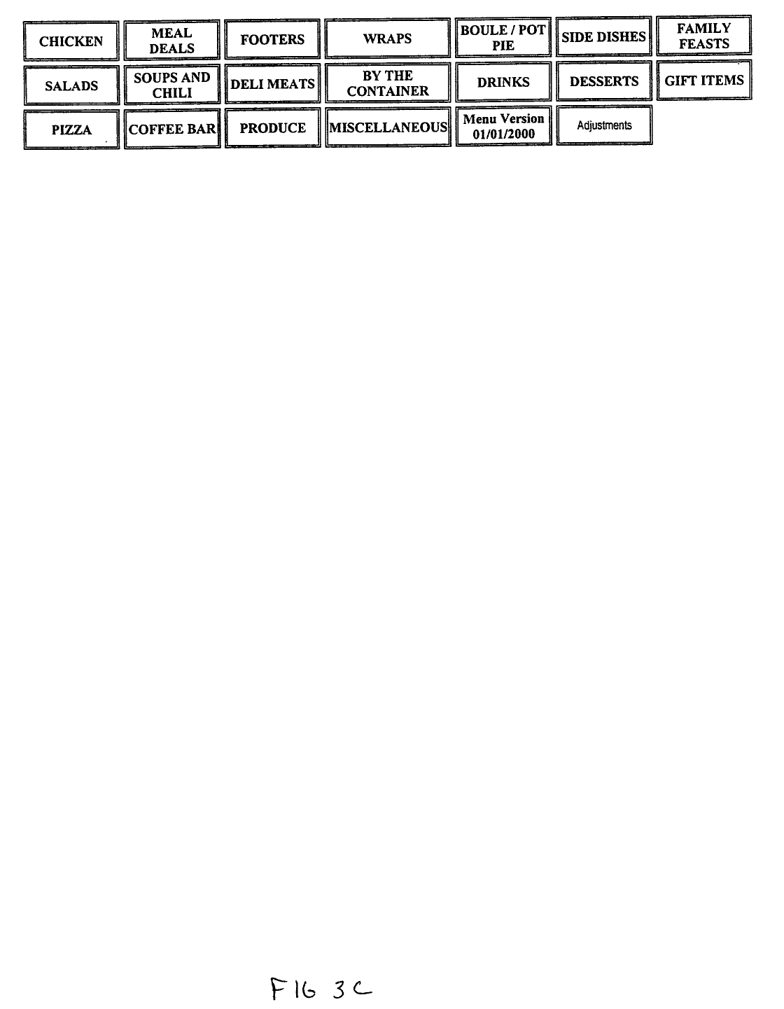

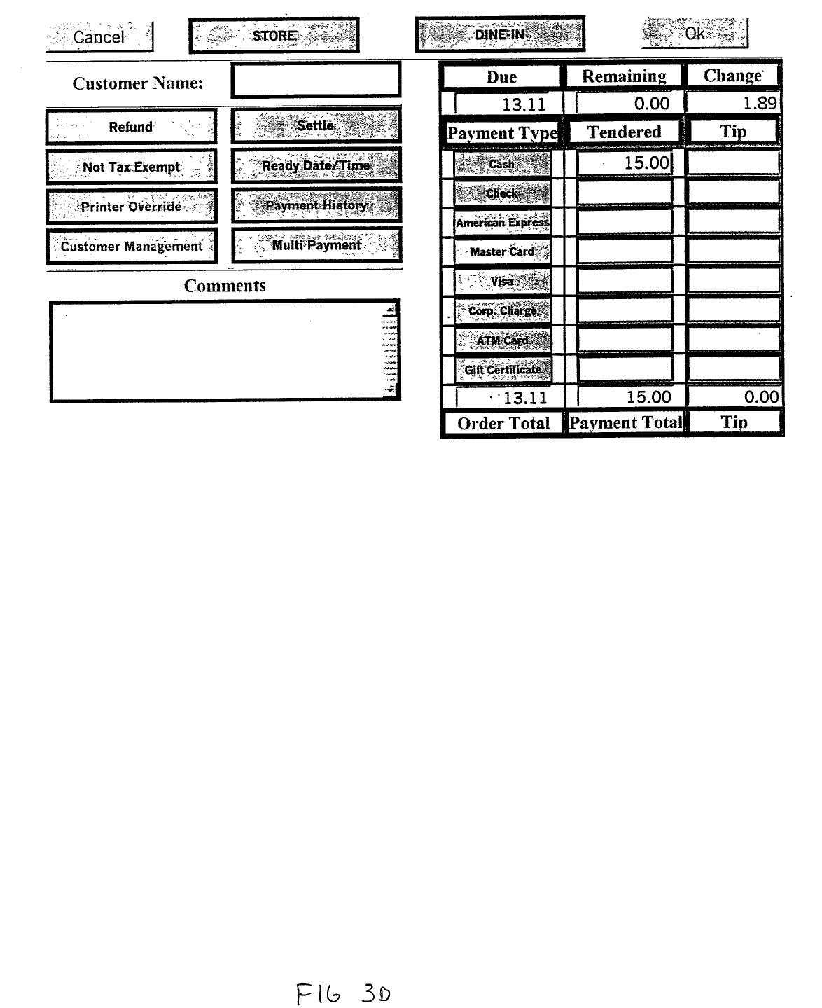

To achieve such functionality, application server 152 hosts at least one web page that forms a user interface to the POS system (described below with reference to FIGS. 3A-3D). Such web pages provide in software all the various functions expected in a POS system (e.g., item selection, pricing, sub and total computations, etc.). Such an application server arrangement is well known, with the front end of a system being stored and served on an application server coupled electronically (via common protocols, for example, SQLNET) to the database, or backend, of the system. One having ordinary skill in the art will immediately understand the configuration described herein.

Each POS terminal 162 can provide standard POS functionality, such as touch screens, cash drawers, etc., and is configured to execute a common web browser, access the global network 175 (e.g., via modem or another network interface, etc.) and download the web pages that make the system's user interface, hosted by application server 152. Accordingly, a store can arrange its POS terminals 162 on a Local Area Network (LAN), as stand alone PC's, dedicated type POS terminals such as those manufactured and marketed by JAVELIN (VIPER machines including touch-screen entry devices), etc. attached to network 175 via a modem or other common network connection, or in any other well known arrangement such that each POS terminal is provided Internet/network access. For example, POS6 is shown directly accessing an ISP and POS5 is shown directly accessing network 175. Each POS terminal 162 may be stationed throughout, such as throughout a retail restaurant establishment, and may be placed anywhere that is accessible to network 175.

Each store location may have a printer facility that is, in the context of the present invention, implemented via print server 170 for printing various POS documents, such as receipts and, restaurant food order tickets, management tally reports and reports, etc. Application server 152 is configured to print jobs to print server 170.

POS system 150 also may include a telephony gateway such as Internet telephony gateway (ITG) 166 which supports voice connections to network 175 which, ultimately, may be processed within POS 150. Such voice connections may initiate at a telephony station 172 (e.g., a telephony based POS station) which accesses a central office CO 170 and, ultimately, a telephony network such as a POTS network (plain old telephone service network). Such an ITG will be readily understood by those skilled in the art and may include voice response systems and devices which are configured to provide voice prompts such as menu prompts, prompts for credit card numbers, etc. which may be used to facilitate POS transactions such as phone-in orders, management requests for reports in real-time received via telephone connections, etc.

It is important to note that POS system 150 may be configured to operate in accordance with and process the POS transactions arising from disparate stores, each store possibly being a multiple facility enterprise. There is no requirement that the present invention must be individually tailored to any particular enterprise; instead, the present invention takes advantage of secure database techniques, relational database practices and paradigms, etc. to allow possibly multiple and disparate enterprises to share resources (and store data in common resources like or similar to central database facility 154) to engage in real-time web enabled e-commerce like POS transactions. Accordingly, the present invention now permits access to POS technologies that have heretofore been out of reach for smaller enterprises.

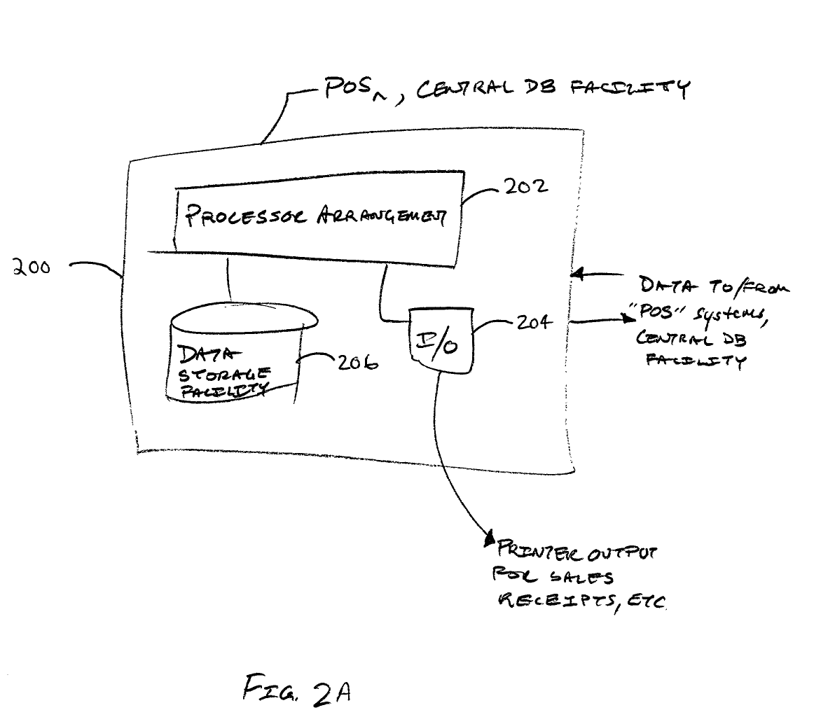

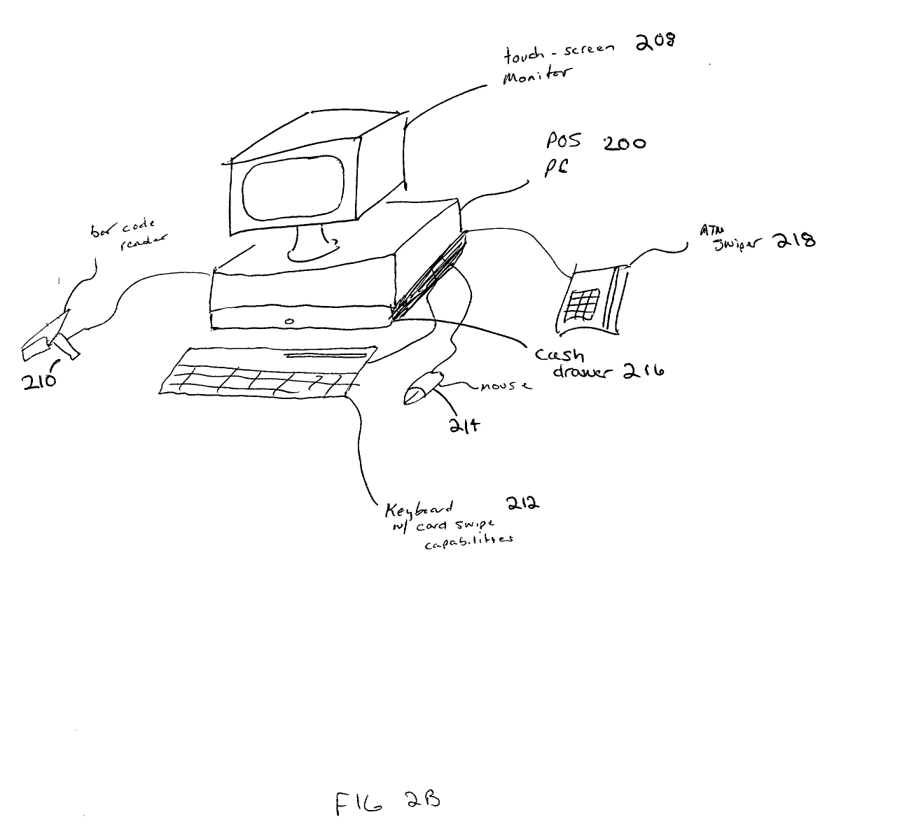

Referring now to FIG. 2A, therein is depicted a block diagram that illustrates an exemplary automatic data processing system (ADP) which may be configured to operate in accordance with the present invention. ADP 200 includes a processor arrangement 202, multimedia input and output device(s) 204, and data storage subsystem 206. ADP 200 is configurable to operate as a web based POS terminal 162 (e.g., an application facility configured to run applications in the form of web pages, etc.), application server 152, central database 154, etc. and could be coupled to a printer and configured to operate as a print server facility such as one that may operated in accordance with print server 170. As such, ADP 200 may be configured to store and serve web pages and other files, to run a database engine, such as SQL-SERVER or ORACLE, and to execute a web browser, such as the NETSCAPE NAVIGATOR/COMMUNICATOR. ADP 200 is further configurable to access/traverse network addresses (e.g., TCP/IP address such as xxx.xxx.xxx.xxx) and network 175. The arrangement and configuration of ADP 200 to operate as a POS terminal 162, application server 152, central database 154, as a print server 170, etc. will be immediately understood by those skilled in the art after reviewing the present invention and this patent document.

Although, to run the present invention, one only needs the ability to access the Internet to access the application server 152 to download and run a user interface within an executing web browser, retail establishments may require additional devices in order to facilitate POS transactions and operations. Accordingly, FIG. 2B depicts a diagram of a POS terminal which may facilitate POS transactions according to a preferred embodiment of the present invention. A POS terminal, for example, a cash box PC, may include a POS processor 202 coupled to a touch-screen monitor 208, a bar code reader 210, a cash drawer 216, an ATM/Credit Card swipe device 218, a mouse 214 and a keyboard with card swipe capabilities 212. POS processor 202 is configured to execute a web browser and to access network 175 to download the user interface from application server 152. An exemplary user interface provided in accordance with the present invention is shown in and is described below with reference to FIGS. 3A-3D. POS processor 202 is configured to accept input data from bar code reader 210, ATM/Credit Card swipe device 218, mouse 214 and the keyboard with card swipe capabilities 212. The cash drawer 216 is used to hold cash for retail cash transactions. Cash box style PC's may be used as POS terminals according to a preferred embodiment of the present invention, but are not required. Cash box style PC's are commercially available and well known and include those manufactured and marketed by JAVELIN (e.g., the VIPER SERIES POS PC).

Having described the structural components of the present invention, operational aspects of the present invention are next described in terms of a user interface, which is shown in FIGS. 3A-3D. The invention is described by way of example as it relates to restaurant applications and, in particular, multiple facility restaurant applications. The present invention, however, is not limited to restaurant applications and instead, can be applied to virtually any kind of retail business that sells goods or services at points of sale.

Referring now to FIG. 3A, depicted therein is a screen shot of a user-interface implemented as an HTML document (web page) that includes mark-up scripts and, possibly, other scripts such as those implemented using enhanced language scripts (e.g., MICROSOFT ACTIVE-X control scripts, Javascript, etc.) and which facilitates a POS system according to a preferred embodiment of the present invention. In particular, a store employee executes a web browser on a POS terminal 162 and accesses the login screen via network 175 to run a POS application provided in accordance with the present invention. The login screen can be configured to address standard security issues (e.g., password, encryption, etc.). As shown here, a password is required to gain entry into the POS system. Also shown in FIG. 3A, an employee may select from a variety of functions: New Order, Last Order, Past Order, POS Console, Clock-In/Clock-Out, Training Menu, and Main Menu.

In addition to the standard POS functions provided by the present invention, the Clock-in/Clock-Out function provides the ability for an employee (e.g., a store clerk, etc.) to remotely “punch-in” their in and out times to facilitate human resource management. For example, when an employee logs-in to the POS system and selects Clock-in, the user-interface may update employee data (e.g., time card data, etc.) stored in the central database 154 based on the user-id and the current time. By managing employee time data centrally and in real-time, the POS system facilitates real-time enterprise employment resource management (e.g., scheduling, etc.). Similarly, corporate training and the like may be remotely managed in real-time through the Training Menu. Such operations can be used to permit enterprise management to obtain and manage teams of people remotely and in real time. For example, a store manager who is sick at home can now log into the POS system provided by the present invention from home and manage personnel needs such as adding staff to address busy times, etc.

User interfaces such as that shown in FIG. 3A can be designed using common web design techniques, such as those used to design and implement HTML or Active Server Pages, and will be readily understood by those having ordinary skill in the art. Moreover, although the present invention is described in terms of HTML documents and the like, the present invention is not limited such designs, and a user interface may be designed using other methods and techniques that enable an application interface to be accessible via a web browser and perform the functionality described herein. It will also be appreciated that the interface shown here is only exemplary, and a user interface may be designed to be more or less user-friendly and to provide more or less functionality as a company's business practices may require.

Once a POS user has logged-in to the system, he or she may select a function, for example, such as the POS console. An example POS console is shown in FIG. 3B. Referring now to FIG. 3B, the POS Console has additional functions: New Order, Last Order, Past Order, Open Drawer (e.g., cash drawer, etc.), Log Off, Activation, etc. These functions are commonplace in a restaurant and will be readily understood by those familiar with restaurant operations. For example, when a customer orders a lunch item, a store employee may login to the system and click on New Order to open an order. The application server will download the web page providing an order form (e.g., such as one containing scripts, etc. to implement form data entry and verification, etc.), a menu, a catalogue, etc. For example, FIG. 3C is a screen shot of a menu associated with a restaurant with buttons for the various types of food items which may be purchased at a point of sale. Clicking on CHICKEN, for example, could drill down to a more detailed description of chicken products served by a particular restaurant. It will be appreciated that the system may be configured to provide unique data relating to a particular store or even a particular terminal by keying on a terminal IP address, for example, a user's ID, etc. Standard object oriented or relational database designs may be applied to the back end (i.e., central database 154), and the data may be managed as a particular business may require. In the present context, a specific store for example, could serve a popular chicken dish that is not sold at any other facility even within a multiple facility enterprise. When a user from a first store logs-in to the system and selects a New Order, the underlying menu will display the special dish. But, when a user from another store logs-in to place a New Order, they will not see the special dish. Thus by providing proper database design, individual store requirements may be implemented within and by the present invention.

Once all the items have been selected in an order, the system may display a web page that facilitates the completion of the order and a sale relative to the order. An example of such a web page is shown in FIG. 3D. Referring now to FIG. 3D, this web page contains the functionality required to perform POS transactions. Accordingly, the web page has buttons associated to the different kind of payments which may be accepted at a point of sale, for example, Cash, Check, American Express, Master Card, Visa, Corp. Charge, Charge Card, ATM Card and Gift Certificate. The web page also has buttons associated with other POS functions, such as to provide a Refund, accept Multi Payment (multiple payment types within a particular transaction), Printer Override, Customer Management, Dine-In, etc. Also, to facilitate the sale, there are fields to be filled in for tendering of payment and tips which relate to data fields in central database 154. An OK button is provided to commit the data transaction to the central database 154.

Using the form shown in FIG. 3D, a company employee, such as the checkout clerk, may total an order and accept payment for the order. Accordingly, the present invention is configured to perform the various forms of POS transactions, such as cash, credit, debit, etc. For example, a terminal such as the one shown in FIG. 2B may be used at a store. The various devices (bar code reader 210, credit card swipe device 212, ATM card swipe device 218, and cash drawer 216) coupled to the terminal are used to facilitate a POS transaction. In the case of a credit card transaction, the card swipe unit built into the keyboard 212 may be used to read a customer's credit card. This data is input into the user interface form as data is entered from a PC's keyboard and submitted to the application server 152. The application server is configured to contact the appropriate clearinghouse facility to authorize and complete a credit card sale based on the order created (e.g., a software package may be executed on the application server 152 to handle credit card payments on the submission of the data). Live data is used from the central database 154. And, after the transaction is complete, a message may be sent to the employee's screen via the user interface web page (e.g., a pop up window, etc.) notifying the employee if the credit card has been approved or denied. Similarly, the ATM swipe device 218 may be coupled to the POS terminal via a serial port or other I/O port. When accepting ATM type payments, a customer's card will be swiped and the data submitted to the application server 152 via the user interface. The application server 152 is configured to use the data submitted to access the appropriate clearing authority to complete the ATM transaction.

Cash transactions can be handled in the conventional manner via cash drawer 216. Data relating to a particular POS terminal's 162 cash drawer 216 is stored in the central database 154 and is updated in real-time based upon POS transactions (e.g., when cash is accepted as a payment, the database can be changed to reflect an increase in the amount of cash in the drawer). The application facility 152 is configured to open the cash drawer 216 of a POS terminal 162 when needed to complete a cash transaction. Such cash drawer operation is quite unique in that the present invention now permits a cash drawer to be opened (such as via an ACTIVE-X control which sends data to an assigned port) such as automatically and in response to completion or settlement of a cash based transaction; accordingly, there is no requirement placed on the part of an operator to actually request opening of a cash drawer such as via a dedicated web form, pop-up screen, etc. Moreover, the present invention's ability to automatically open a cash drawer provides a level of security for POS transactions and operations to protect an enterprise owner or operator from employee theft of monies, etc. This can be performed by sending a message to the associated serial/parallel port relating to the cash drawer 216. For example, an ACTIVE-X control could be used to cause a web browser to send a message (e.g., string of at least one character, etc.) to the associated port address.

After the sale transaction is complete, a receipt can be printed manually or automatically as desired. Since all the data relating each transaction is committed to the central database 154 in real-time, a receipt can be printed relating to any transaction. The application server 154 is configured to send a print job to a network printer or to the print server 170 directly. The print job can be sent via IP or IPX or could be performed using conventional remote printing techniques such as those implemented using a line printer daemon within a UNIX or UNIX like operating system, for example, etc. Or, the application server 152 or the client browser could create a print file relating to the print job (such as by wrapping a print job in an HTML header and compressing the file as a MICROSOFT Windows Enhanced Metafile (EMF)) and send the file to the print server 170 using HTTP PUT or other similar methods. The print server 170 can be configured to handle print files and print the job to the appropriate printer.

For example, a client program could be used to create a standard Windows print job and transmit it to the server component. Creating the print job can be done one of two ways: using a structured graphics tool and saving the file as a MICROSOFT Windows Enhanced Metafile (EMF), or under programming control using the plug-in components such as vsView which is manufactured and marketed by VIDEOSOFT. The second option may be used when formatting database output into a customer-designed style. Programmatically a print job can be created, including setting fonts, sizes and colors, placing the text in columns and tables, and rendering formatted text in Rich Text Format (RTF). In addition, basic Hypertext Markup Language (HTML) tags, the formatting used for pages on the World Wide Web (WWW), can be sent, allowing many different ways to control the printed output. Structured graphics and bitmap graphics, various page sizes and orientations, all can be included in a single print job. Using this second option to create an EMF can be accomplished by using, for example, vsView's SaveDoc method, which renders the commands necessary to draw to the printer to a file instead. That file is the same as an EMF created in any other way, and has the advantage of being compressed reducing the size of the file to be transmitted. After the EMF file has been created and saved to disk, it needs to be sent to the print server 170 using the HTTP protocol. However, instead of using port socket 80, any port can be used as long as both the client and server are identical. Therefore the same machine that serves up WWW pages can also be used as a global print server. The print file is “wrapped” with custom tags that identify the name of the printer the server should render to, and the actual EMF data file. The client creates a document to be sent composed of the following parts: “PRINTERSTART” and the name of the printer device to render to, followed by “PRINTEREND”; “PARTSTART” and the complete compressed print job, followed by “PARTEND.”Such a document is composed in memory and is then transmitted to the server component using the HTTP PUT method.

Print server 170 is configured to handle print jobs via a server program that has three roles: to accept any number of simultaneous connections to validate their content; to render the content to the selected printing device; and to respond with a success or failure header using HTTP. Once the client connects, the server acts like a WWW server, creating a port for reception of information. The server can process as many simultaneous connections as are necessary, creating a fresh socket for each. After the socket is created and a connection established, the server takes the client's data and parses it to find the printing device name and the EMF data. If this fails the server responds with an HTTP header containing an error number and descriptive text. If the document is in the proper format, the server attempts to connect to the desired printer and send the EMF data using the vsView control. If there is an error such as the printer doesn't exist or there is a rendering error, an error header as described above is returned. If the job succeeds, a success header is returned. The server then closes the socket and frees the printer connection, and continues with the next job if ready, and otherwise it returns to a listening mode for another job.

Methods of remote printing from an application server or from a web browser are well known, and such techniques will be readily understood by those having ordinary skill in the art.

It will be appreciated that many devices can be added to a POS terminal to facilitate data entry. For instance, bar code reader 210 could be used to enter data relating to an item. The POS terminal 162 simply needs to be configured to accept such data from the external source into the browser, such as via keyboard I/O or other method. Once data is transferred into the browser, the central database 154 can be updated via user interface forms. Consequently, as new technology is developed, the present invention may incorporate such peripheral devices in order to more effectively facilitate POS transactions.

Also, it will be appreciated that because the present invention stores data centrally and in real-time, any POS related function may be performed relating to data stored in the central database 154. Such functions included those related to producing a restaurant ticket, a refund, a gift certificate, etc. may be performed using the present invention. Pricing data can be changed company wide instantaneously. Furthermore, since all data including transaction data is stored centrally and in real-time, stores may view data anywhere a web browser permits. Therefore, such things as, for example, “bump bar” terminals may be provided for restaurants by adding web pages that query live order data. Furthermore, any enterprise management functions may be designed into the application, such as sales reporting, store reconciliation, etc.

And, the present invention permits “back-office” operations such as management reporting operations (e.g., queries related to sales of particular and groups of items, inventory reports, etc.). to be done via a web interface. Since data including transaction data related to POS transactions is centrally stored in real-time, such back-office operations may carried out at any given time to obtain, for example, an accurate up-to-the-minute view of enterprise performance, etc.

The structural aspects of the present invention preferably utilize open standards technologies and protocols (e.g., HTTP, TCP/IP, etc.) to facilitate real-time, web based POS operations via a publicly accessible network such as the Internet and WWW. The present invention, however, is not so restricted. To the contrary, dedicated communications links may be used to access a private POS network that may utilize such open standards technologies.

### Operational Aspects of the Present Invention

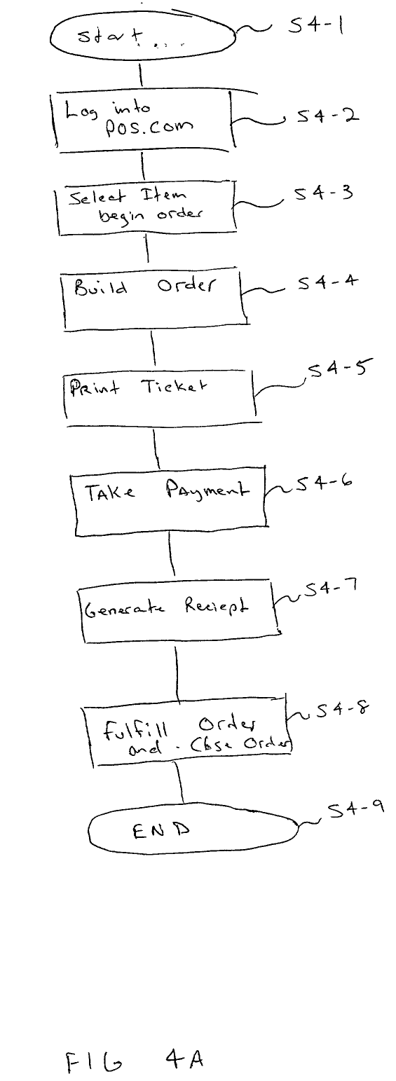

The structural aspects of the present invention as described in detail above with reference to FIGS. 1B, 2A, 2B, 3A, 3B, 3C, and 3D are designed and configured to operate together to achieve the functionality described herein. Such functionality is achieved via operations and processes which are next described with regard to FIG. 4.

With specific reference to FIG. 4, depicted therein is a flowchart that illustrates a method which may be used within system 150 (FIG. 1B) to facilitate POS operations in real-time via a web connection in accordance with a preferred embodiment of the present invention. Processing and operations begin at step S4-1 and immediately proceed to step S4-2.

At step S4-2, a store employee logs-in to POS system 150, such as through a web site via a web browser, for example, by accessing a web site such as www.pos.com. At the web site, a login web page may be provided with standard security and functionality, such as the web page already described above with reference to FIG. 3A. Once a store employee has logged into POS system 150, processing proceeds to step S4-3.

Next, at step S4-3, the store employee begins to take an order. Web pages, such as the ones already described above with reference to FIGS. 3A-3D, can be provided to access in real-time goods and services data from a central database and an order can be commenced via an online transaction. As already described above, POS terminals may be equipped with bar code readers that may assist the creation of an order, for example, by reading data about an item from a tag on the item.

Next, at step S4-4, the user builds the order. An employee builds the order by entering data related to the order. Web pages can be provided that facilitate the building of the order as a company may require. Accordingly, on-line menus or catalogues may be provided or other types of forms that facilitate the entry of an order. Examples or such forms are already described above with reference to FIGS. 3A-3D.

Next, at step S4-5, a ticket can be printed. In the context of a restaurant, the order ticket or kitchen ticket can be printed based on the data entered, or a separate web page could be provided to display/manifest such data to the appropriate individual. Printing and displaying of data is accomplished as already described above.

Next, at step S4-6, the employee may take payment relating to the order. As already described above, the invention may be configured to accept all types of payment vehicles. For example, as described above, the POS system is configured to remotely open a cash drawer in order to facilitate a cash transaction, or to accept credit card data via a card swipe device to process a credit card transaction, etc.

Next, at step S4-7, after payment has been accepted, a receipt may be printed. As already described above, the invention is configurable to print receipts to a print server or to a printer directly. Since all data is stored in real-time and centrally, a receipt can be printed on any POS transaction that has been submitted and to any remotely located printer by means of the methods already described above.

Next, at step S4-8, the order is fulfilled and closed/settled. Once payment has been received, the only thing that is left is the fulfillment of the order. In the case of a restaurant, when the food is provided to the customer, the outstanding order may be closed. Web pages may be provided that display and manage an order to completion. For example, a cook may be provided with a web page that he may update when he completes an order. In other retail applications, there may be no need to complete the order, completion of the sale may be used to force an order closed.

Finally, at step S4-9, operations end.

The method steps illustrated in FIG. 4 are generally applicable to web based POS operations provided in accordance with the present invention. That is, a management operation related to POS transaction may involve accessing central data storage facilities via the WWW and engaging in what may otherwise be considered an on-line query which is processed within system 150. Moreover, the method describes by way of example how the present invention facilitates a POS transaction in terms of taking a food order in the context of restaurant operations. However, the present invention may be used to facilitate any POS transaction. Accordingly, the detailed language found within the method steps of the flowchart illustrated in FIG. 4 are not intended to limit or otherwise restrict the present invention and its ability to facilitate and provide real-time web based POS operations.

Thus, having fully described the present invention by way of example with reference to the attached drawing figures, it will be readily appreciated that many changes and modifications may be made to the invention and to any of the exemplary embodiments shown and/or described herein without departing from the spirit or scope of the invention which is defined in the appended claims.

What is claimed is:

1. A point of sale system, comprising:
a central database facility storing and maintaining data relating to items to be sold at a point of sale and at least one user interface; and
an application facility coupled to said central database facility via an electronic data network and configured to access said central database facility to receive said data related to said at least one user interface, to process said at least one user interface within a browser application executing within said application facility, and to process said data relating to said items in real-time via said at least one user interface to facilitate a POS operation related to said items.

2. The system according to claim 1, wherein said electronic data network is the Internet and said browser application is a web browser.

3. The system according to claim 1, wherein said data includes enterprise data related to said items, said application facility is further configured to permit enterprise management functions related to said enterprise data.

4. The system according to claim 1, wherein said user interface contains at least on HTML document containing facilities configured to permit said at least one user interface to operate within said browser application.

5. The system according to claim 1, wherein said at least user interface operates to permit operation and verification of user-entered data related to at least one item from among said items to be sold at said point of sale.

6. The system according to claim 1, wherein said application facility is coupled to a cash drawer, said at least one user interface configured to control operation of said cash drawer based on said POS operation.

7. The system according to claim 1, wherein said application facility is coupled to a cash drawer system, said cash drawer system is configured to automatically open in response to operation of said at least one user interface when said POS operation is a cash money transaction.

8. A system for facilitating real-time web based point of sale operations, comprising:
a central database management facility storing and managing data related to at least one user interface form operable within a browser application and to items which may be sold at a point of sale; and
a plurality of client data processing facilities coupled to said central data management facility via an electronic data network, each client data processing system of said plurality of client data processing systems located at a remote point of sale and coupled to said central data management facility via a network connection over said electronic data network, each client data processing facility configured to execute said browser application, to access said central database management facility via said network connection to retrieve and process said at least one user interface form within said browser application, to access said central database management facility in real time to retrieve data related to at least one of said items to facilitate a remote point of sale related operation, and to cause said central database management facility to manage said data about at least one of said items based on said remote point of sale related operation.

9. The system according to claim 8, wherein said central database management facility is a web enabled server system configured to process web based transactions received via electronic data network and at least one client data processing facility from said plurality of client data processing systems.

10. The system according to claim 8, wherein said browser application is a web browser client and said at least one user interface form is a web document containing fields to be filled in within said browser application.

11. The system according to claim 8, wherein said at least one user interface form is a self-contained software package configured to be executed within said browser application and configured to permit user entry of data to be transmitted to said central database management facility via said electronic data network.

12. The system according to claim 8, wherein at least one client data processing facility among said plurality of client data processing facilities includes a cash drawer configured to be operated based on said at least one user interface form.

13. The system according to claim 12, wherein said central database management facility is further configured to store and manage data related to said cash drawer and said client data processing facility is further configured to execute said browser application, to access said central database management facility via said network connection to retrieve and process said at least one user interface form within said browser application, to access said central database management facility in real time to cause said central database management facility to manage said data related to said cash drawer based on said remote point of sale related operation.

14. The system according to claim 8, wherein said self-contained software package includes script instructions configured to control user-entry of data within said browser application.

15. A method for facilitating real-time, web based point of sale operations, comprising the steps of:
at a central database facility, storing and maintaining data relating to items to be sold at a point of sale and at least one user interface;
permitting access to said central database facility to receive said data related to said at least one user interface;
processing said at least one user interface within a browser application executing within an application facility; and
at said application facility, processing said data relating to said items in real-time via said at least one user interface to facilitate a POS operation related to said items.

16. The method according to claim 15, wherein said permitting step is performed to allow a user to access said central database facility via an electronic data network.

17. The method according to claim 16 wherein said electronic data network is the Internet.

18. The method according to claim 15, further comprising the step of controlling a peripheral device coupled to said application facility based on said POS operation.

19. The method according to claim 18, wherein said peripheral is a printer.

20. The method according to claim 18, wherein said peripheral is a cash drawer.

21. The method according to claim 15, wherein at least one user interface is at least one electronic form operable within said application facility, said at least one electronic form permitting user input and controlling said application facility to process said user input and to update said data stored and maintained by said central database facility.
